(19) United States
(12) Patent Application Publication
(10) Pub. No.: US 2019/0354874 A1
(43) Pub. Date: Nov. 21, 2019

(54) PLATFORM FOR AUTONOMOUS AND GOAL-DRIVEN DIGITAL ASSISTANTS

(71) Applicant: Agentz, Inc, Fremont, CA (US)

(72) Inventors: Ketan Shah, Fremont, CA (US); Arunkumar Sivakumar, Fremont (IN)

(73) Assignee: Agentz, Inc, Fremont, CA (US)

(21) Appl. No.: 16/414,245

(22) Filed: May 16, 2019

Related U.S. Application Data
(60) Provisional application No. 62/672,539, filed on May 16, 2018.

(51) Int. Cl. G06N 5/02; G06F 16/28

(52) U.S. Cl. CPC G06N 5/02; G06F 16/285

(57) ABSTRACT

Embodiments herein disclose a computerized method for goal-driven conversation. The method includes training a conversation agent using a conversation catalog and receiving configurations for the conversation agent. The configurations include task configurations, a goal plan, and event conditions. Further, the method includes receiving by the conversation agent input from a user. Further, the method includes checking a system for inputs for given user input. Further, the method includes processing the input through one or more stages from the group. The stages include objective analysis to analyze to identify objective of the input, event analysis to evaluate event conditions and check for goal triggers for matching event conditions, and goal analysis to determine next conversation based on the goal plan. Further, the method includes making conversational interaction with the user based on analysis.

This application claims the benefit of U.S. Provisional Application No. 62/672,539, filed May 16, 2018.

### TECHNICAL FIELD

The embodiments herein relate to Artificial Intelligent (AI) systems, and, more particularly, to applied AI systems to enable natural conversations with humans in specific domains or application areas.

### BACKGROUND

The web is becoming more conversational. Automated conversational agents (also commonly referred to as “chatbots”) are becoming more popular as a medium of interaction.

However, todays conversational agents come with severe limitations. Most of todays conversational agents are programmed to look at a limited set of Frequently Asked Questions (FAQs) to provide answer to a given question or to provide a predefined and guided Question and Answer (Q&A) while presenting user with a set of limited choices to choose from. Essentially, these conversation agents rely on predefined conversation flows. These conversational flows are decision trees which drive the conversation between a human user, another conversational agent or a computer program. Since these conversations are driven by a set of anticipated input parameters or conversation conditions, any “off script” interaction may quickly render the conversations inconclusive and could hit a dead end, especially when the input is unanticipated or does not match pre-defined inputs or conditions.

Today, conversational platforms perform two major functions to process an interaction: 1. Process the input instruction by understanding its meaning and identifying its intent, and 2. Generate the output information by using logic. Currently, the logic used for the generation of the output is configured with predefined branching logic which does not offer flexibility for handling unexpected conditions other than executing default outputs.

### SUMMARY

Accordingly, embodiments herein disclose a computerized method for goal-driven conversation. The method includes training a conversation agent using a conversation catalog and receiving configurations for the conversation agent. The configurations include task configurations, a goal plan, and event conditions. Further, the method includes receiving by the conversation agent input from a user. Further, the method includes checking a system for inputs for given user input. Further, the method includes processing the input through one or more stages from the group. The stages include objective analysis to analyze and identify objective of the input, event analysis to evaluate event conditions and check for goal triggers for matching event conditions, and goal analysis to determine next conversation based on the goal plan. Further, the method includes making conversational interaction with the user based on analysis.

In an embodiment, the conversation catalog includes one or more subject definitions, relationships between subjects, where there are more than one subject definitions, operations that can be performed, and conditions and filters that can be applied in retrieving information.

In an embodiment, the task configuration includes task definitions including specific actions, one or more instructional triggers for branching a conversation, and one or more functional triggers for branching a conversation.

In an embodiment, the goal plan includes a set of one or more tasks, priority associated with each of the one or more tasks indicating order of execution of tasks, and one or more conditional triggers for branching out of goal plan.

In an embodiment, the method includes triggering one or more associated goal events when an event condition is satisfied.

In an embodiment, the method includes executing a chain of associated goal tasks with at least one task when a goal event is triggered. Executing a goal task includes invoking a pre-configured instruction and invoking a pre-configured function, where executing the first task in the chain of associated goal tasks results in executing further tasks in the chain when there is more than one task in the chain.

Accordingly, embodiments herein disclose a system for goal-driven conversation. The system is configured to train a conversation agent using a conversation catalog. Further, the system is configured to receive configurations for the conversation agent. The configurations include task configurations, a goal plan, and event conditions. Further, the system is configured to receive by the conversation agent input from a user. Further, the system is configured to check the system for inputs for given user input. Further, the system is configured to process the input through one or more stages from the group. The stages include objective analysis to analyze to identify objective of the input, event analysis to evaluate event conditions and check for goal triggers for matching event conditions, and goal analysis to determine next conversation based on the goal plan. Further, the method includes making conversational interaction with the user based on analysis.

### BRIEF DESCRIPTION OF THE FIGURES

The embodiments herein will be better understood from the following detailed description with reference to the drawings, in which:

FIG. 1 shows a simple configuration of a goal plan, conditions, goals, and related tasks, according to the embodiment as disclosed herein;

FIG. 2 is a schematic diagram illustrating a conversational platform and its major components along with client devices accessing the conversational platform over a communication network, according to an embodiment herein;

FIG. 3 is a block diagram illustrating an application server, according to the embodiment as disclosed herein;

FIG. 4 is a block diagram illustrating a conversation server, according to the embodiment as disclosed herein;

FIG. 5 is an example scenario of a database showing various kinds of data that can be stored in the database, according to the embodiment as disclosed herein;

FIGS. 6 and 7 are illustrating flow diagrams of a process of engaging in a conversation with a user by an agent configured on a conversation platform, according to the embodiment as disclosed herein;

FIGS. 8 and 9 are illustrating flow diagrams of a process for executing a task, according to the embodiment as disclosed herein;

FIG. 10 is a conversation memory map, according to the embodiment as disclosed herein;

FIG. 11 is an example scenario in which a user interface is depicted for designing, configuring, customizing and populating custom data-types, according to the embodiment as disclosed herein;

FIG. 12 is an example scenario in which a user interface is depicted for creating data entities and its related fields, according to the embodiment as disclosed herein;

FIG. 13 is an example scenario in which a user interface is depicted for creating and maintaining context training, according to the embodiment as disclosed herein;

FIG. 14 is an example scenario in which a user interface is depicted for creating and maintaining events, according to the embodiment as disclosed herein;

FIG. 15 and FIG. 16 are illustrating example scenarios in which a user interface is depicted for creating, configuring and customizing tasks, according to the embodiment as disclosed herein;

FIG. 17 and FIG. 18 are illustrating example scenarios in which a user interface is depicted for creating and maintaining goals, according to the embodiment as disclosed herein;

FIG. 19 and FIG. 20 are illustrating example scenarios in which a user interface is depicted for creating and maintaining agents, according to the embodiment as disclosed herein; and

FIGS. 21-23 are illustrating example scenarios in which a user interface is depicted for designing, configuring and customizing goal plans, according to the embodiment as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose a conversational platform and associated methods to configure a conversational agent for generating conversations in one or more domains.

In a preferred embodiment, the conversational agent is driven by set of configurable goals rather than predetermined flows based on anticipated inputs or conditions. The agent is responsive to a set of objectives or a goal plan and is also sensitive to events triggered by some conditions.

In various embodiments, the conversational agent digests information, breaking down unstructured data into structured data structures and understanding its meaning so that the acquired knowledge can be used during interactions with other entities.

An interaction can be an exchange of information between two or more entities (entities can be human or software applications running on any device like mobile, desktop, tablets, Internet of Things (IOT) devices, embedded devices and any other similar device which can run a software program and communicate with other entities). Communication between entities can take place through commonly understood mechanisms (for example, REST API: REpresentational State Transfer Application Programming Interface). An interaction consists of an Input instruction and Output information, both in natural language or unstructured signals via any medium like voice, text, audio, video, image, telemetry etc. Multiple interactions make up a Conversation.

In various embodiments, the conversational platform achieves autonomous conversation generation by referring to a conversations catalog. The conversations catalog can be configured through one or more graphical user interfaces (GUI). The conversations catalog defines the data structures to represent Subjects, which comprises of any topic or its related details within the domain in which the conversations have to happen. Each Subject can include the appropriate data structures to store relevant information about itself and also to specify the various operations which can be performed on those data structures to retrieve information based on any combination of conditions and filters. The conversational catalog can also include data structures to specify and store the various possible relationships between the subjects.

In various embodiments, the conversational platform allows an interaction to be configured as a Task. The task configuration can be done through one or more graphical user interfaces (GUI). Each task can have associated logic which needs to be performed by the conversational platform to service the conversational input. The conversational agent understands the meaning of the information by parsing unstructured data into structured data structures so that the acquired knowledge can be used during interactions with other various domains, whereas a language conversational platform converts multiple languages into a common language for the conversational agents and process the information in the language of user preference in the conversational agents. Each task can further include instructions and functions which will initiate branching conversations to fulfill them. These conversation outputs can be autonomously initiated by the conversational platform based on pre-trained conversations catalog.

A goal plan is a workflow of goals which provides a blueprint for the conversational platform to decide its next output. The goal plan provides information on the order in which the goals should be executed. It may also include conditions through which the goal plan may branch out into different paths. The goal plan can be configured using one or more graphical user interfaces (GUI). Goals can be mapped to one or more underlying Tasks.

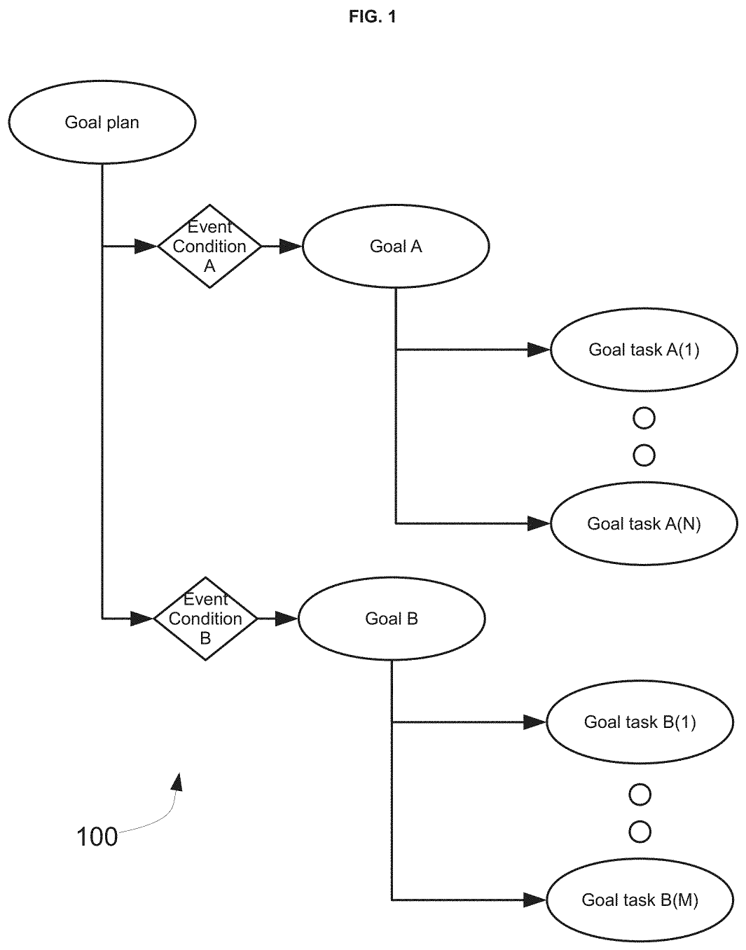

In various embodiments, in addition to the goal plan, event conditions can be configured which when evaluated and found to be true, will trigger goal events. Whenever a goal event is triggered, the corresponding goal's tasks will be performed which in turn may invoke an instruction or a function in the task which helps the conversational platform to autonomously generate furthermore conversations. The event conditions will be configured through one or more graphical user interfaces (GUI). FIG. 1 shows a simple configuration 100 of the goal plan, conditions, goals, and related tasks. Depending on the goals and tasks, the configuration 100 can be much more than that as shown in FIG. 1. It is to be noted that the configuration 100 is a meta-configuration of goal and tasks as opposed to a comprehensive set of questions and answers as used by present systems.

During a conversation, the conversational platform may use conversation log and a data structure to store the conversation's interactions, the associated events, the input and generated data, and all other information about the conversation for reference during runtime to autonomously predict conversations.

Further, the conversation logs add following two major capabilities to a digital agent:
1) Look up already obtained/deduced information so that the digital agent doesn't have to ask for the same information from the user again and again. In an example, for a booking an appointment, user's name, contact email/phone and a convenient time slot are required information. If the user has already provided their name and contact details previously during the conversation, the digital agent may check the conversation log to make sure it has those values and decide to ask the user for the time slot alone, instead of asking for all three values again when it executes the task to book an appointment.
2) Predict possible queries the user may ask next and proactively provide information. In an example, the conversation log details across the conversations will be used to extract the most asked query sequences to predict the next possible user query. The information for a possible future question in the conversation may be provided proactively to the user to improve service provided. For instance, the agent may deduce that most of the users who talk to a dental agent start with “What services do you provide” question followed by “Do you support my insurance” and then “Book an appointment”. This may help the agent to predict the information which the user may require next. So, when the user starts by asking about the services, the agent may respond by displaying the services provided along with the list of insurances supported by the business and a list available appointment slots to the user. This way the user gets all the answers they needed during the conversation (for even questions they haven't asked yet).

In various embodiments, the conversational platform may constantly receive inputs and feedback from a plurality of sources during the duration of a conversation. The input sources could be, including but not limited to, an input from a correspondent or a system generated event based on some condition or a system instruction to perform a new task. These inputs will be processed through a variety of stages and priorities before the conversational platform can predict and autonomously generate appropriate conversations.

In a preferred embodiment, the stages can include but are not limited to objective analysis (first priority), event analysis (second priority), and goal analysis (third priority).

In a preferred embodiment, the first priority in processing the input can be objective analysis using an objective analyzer. The interaction input is analyzed to identify the objective of the input. Each objective will be mapped to one or more tasks which can further be performed by the conversational platform. In the event of the objective analyzer not being able to determine a task for the input, the conversational platform will execute a fall back task to generate a response. After servicing this objective, the conversational platform will determine its next step based on real time system feedback or correspondent's input it gets at that instant.

When there are no inputs from the correspondent, the conversation generation process can proceed to the event analysis using an event analyzer. In this stage, the input may be reformatted into a different data structure which is relevant for the event analyzer to process. Using the input and the information referenced from the conversation log, all configured event conditions can be evaluated to check for triggers. The event conditions trigger the associated goal. When multiple triggers are active, the conversational platform can use a tie breaker logic to decide on goals and/or the order in which the goals have to be executed.

When there are no active triggers, the conversational platform can proceed to the goal analysis using a goal analyzer. This stage uses the goal plan to decide how to generate the next conversation. The goal analyzer checks the goal plan to understand the next pending goal to proceed. In various embodiments, the conversational platform may allow switching between different input objectives during the course of a conversation. After servicing the new objective, the conversational platform can switch back to the previous pending objective. To be able to switch objectives, during a conversation, all information about the interactions can be stored in the conversation log. The conversation log may also include each and every instruction being executed and the status of instruction (for example, to indicate whether the associated actions are completed or in progress). Using this information, the conversational platform can pick up progress from previously executed objectives and continue execution. During the execution of a goal and its associated task, the conversational platform may encounter instructions which may need to operate on subjects, like collecting information about subjects. The conversational interactions required to collect information about subjects can be autonomously generated based on the corresponding subject's conversations catalog. Thus, the conversational platform can generate required conversations autonomously and also handle processing and storing of input information. Based on input information for an autonomously generated interaction, the cycle of processing it in one or more of the three stages can repeat to derive the next autonomously generated conversation. This cycle may consist of both the goal driven autonomous conversation generation and the goal event based autonomous conversation generation.

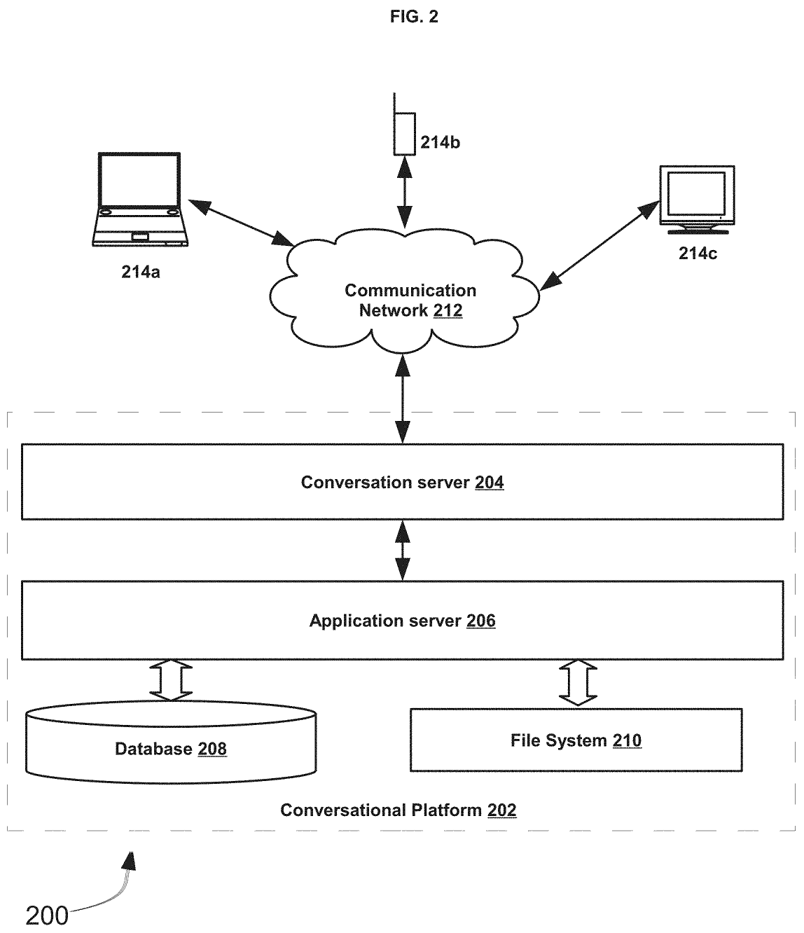

Referring now to the drawings, and more particularly to FIGS. 2 through 6, where similar reference characters denote corresponding features consistently throughout the figures, there are shown embodiments.

FIG. 2 is a schematic diagram illustrating the conversational platform 202 and its major components along with client devices 214a-214c accessing the conversational platform 202 over a communication network 212, according to an embodiment herein. As shown in the FIG. 2, a system 200 includes a conversational platform 202, a conversation server 204, an application server 206, a database 208, a file system 210, a communication network 212, and a set of client devices 214a-214c.

In the example embodiment shown in FIG. 2, the conversational platform 202 includes the application server 206 to serve requests to the user accessing the conversational platform 202 from various types of client devices 214a-214c, a conversation server 204 for processing inputs from the users and providing necessary feedback to agents running on client devices 214a-214c, and the database 208 for storing data relating to users, configurations, machine learning models, conversation catalogs, conversation logs and relevant metadata. In addition to the database 208, the conversation server 204 may also store and retrieve data from the file system 210 (for example, training data).

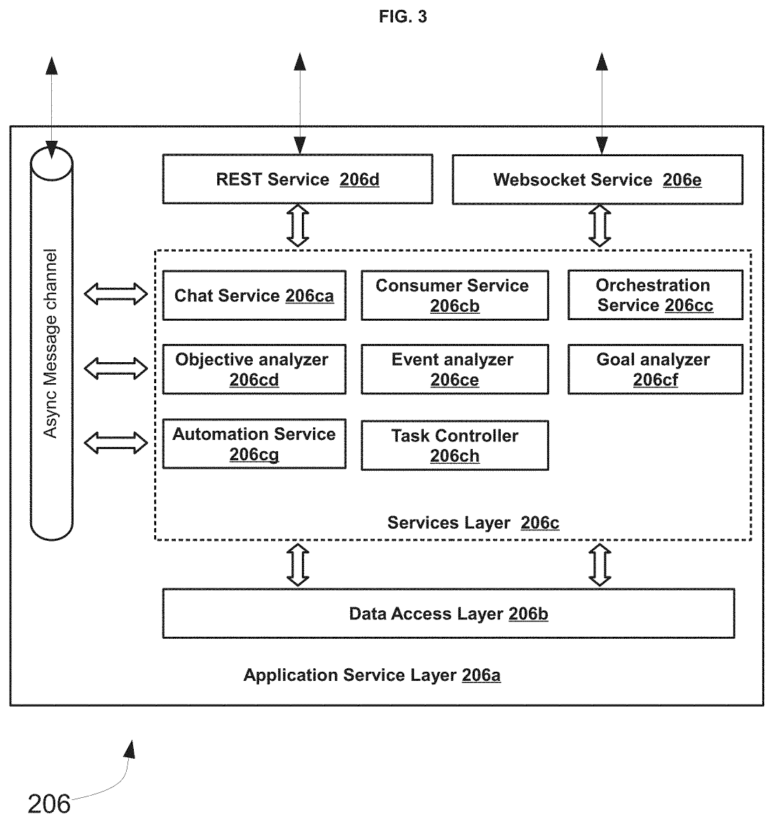

FIG. 3 is a block diagram illustrating the application server 206, according to the embodiment as disclosed herein. In an embodiment, the application server 206 includes an application service layer 206a, a data access layer 206b, a services layer 206c, a rest service 206d, a websocket service 206e, and an async message channel. The data access layer 206b, the services layer 206c, the rest service 206d, and the websocket service 206e are communicated with each other. Further, the services layer 206c includes a chat service 206ca, a consumer service 206cb, an orchestration service 206cc, the objective analyzer 206cd, the event analyzer 206ce, the goal analyzer 206cf, an automation service 206cg, and a task controller 206ch. The chat service 206ca, the consumer service 206cb, the orchestration service 206cc, the objective analyzer 206cd, the event analyzer 206ce, the goal analyzer 206cf, the automation service 206cg, and the task controller 206ch are communicated with each other through the async message channel.

Further, the chat service 206ca is an initiation point for any new conversation. After initiation of the new conversation, the chat window, for instance, will connect with the chat service 206ca first to present its credentials and open a session to start a conversation between the users. The chat service 206ca calls the consumer service 206cb to authenticate and obtain a live session for the conversation.

Further, the consumer service 206cb manages the authentication of the user/business credentials. Further, the consumer service 206cb creates the user session for the conversation and also a dedicated websocket connection for exchanging the chat information between the users.

Further, the websocket service 206e opens a socket connection to the user's chat window through which all chat interactions occur. Any user request comes through the websocket service 206e and is passed on to the conversation service. The digital agent's response from the conversation service is sent to the websocket service 206e through which it instantly reaches the user's chat window.

The orchestration service 206cc coordinates with the intent analyzer (to understand the user's intention). Based on the user's intention, the task controller 206ch executes the appropriate task. All user requests pass through the conversation service to the orchestration service 206cc for processing. Further, the automation service 206cg stores all the configuration metadata of the digital agent. The orchestration service 206cc calls the automation service 206cg to retrieve all the configuration details it requires to understand and service the user's request.

The objective analyzer 206cd processes and analyses the user input to identify the objective. The input can be the user input or the like. The objective will be mapped to one or more tasks which can further be performed by the conversational platform 202. Further, the event analyzer 206ce analyses to evaluate the event conditions and checks for goal triggers for matching event conditions. In an embodiment, the event conditions are determined from the user's conversation. Further, the goal analyzer 206cf analysis to determine next conversation based on the goal plan and triggers one or more associated goal events when the event condition is satisfied.

The rest service 206d utilizes the HTTP for accessing one or more services, and the data access layer 206b interacts with the application service layer 206a, the services layer 206c, the rest service 206d, and the websocket service 206e for accessing the data.

In an embodiment, when the conversation platform is not able to identify the intent of the user input with a required confidence score, it uses the ambiguity resolution algorithm to identify the most likely intents the user may be talking about. These likely intents will be shown to the user as possible suggestions for them to continue their conversation. The challenge is to create an algorithm which can provide best results with almost no extra training for the machine learning model. Since the algorithm cannot have large amounts of training data and has to use existing training data to predict equivalence, our algorithm follows a hybrid method of precise logic programing steps mixed with artificial intelligence programs.

The algorithm uses a five step process logic to analyse the user input. Each of the 5 steps use machine learning models to predict their step level results. These results are finally applied to a custom formula which produces the final result.

Steps involved in ambiguity resolution are as follows. Each step produces a confidence score which is applied to a final formula to predict the final resolution score.
1. Intent analyzer
2. Keywords matching (synonyms and lemmatization matching)
3. Question category identification
4. Vector matching
5. Final confidence score formula

The objective analyzer 206cd classifies the user query into one or multiple intents. The two components are the baseline of the analyzer, namely Pretrained Embeddings (Intent_classifier_sklearn) and Supervised Embeddings (Intent_classifier_tensorflow_embedding). Keywords are the words extracted from the user query after removing stopwords (is, but, and, what, why etc). These keywords are supposed to be the topic of the user message (the topic of interest which the user is talking about). The list of these keywords is extended by adding synonyms of each keyword along with any custom synonyms which may have been configured.

This list is further enhanced by applying lemmatization for each keyword and all other lemmatization forms of it added to the list. The same procedure is applied to each statement in the training data as well. These keywords lists of user input and each of the training statements is compared to look for similar keywords. The scale of equivalence between the two lists gives a confidence score for this step.

The user input is passed through a question category prediction algorithm which classifies its top level intent category. Each statement in a conversation will fall under at least one of the categories. Some of the intent category examples are describe_person_intent, ask_datetime_intent, ask_help, describe_place_intent etc.

The same procedure is applied on each statement of the training data as well and their intent categories are found. The scale of equivalence between these intent categories gives a confidence score for this step.

Au query is converted into the string vector using the Spacy library along with glove model and compared with the trained intents in the vector format. The comparison score is calculated based on the Euclidean distance.

The final score will be calculated based on the following formula:—

Final equivalence score: intent_analyzer_score*0.3+question_category_score*0.1+vector_score*0.1+keywords_synonyms_score*0.5

The following tables illustrate the final equivalence scores for various user inputs:

1. User input: how should I take care of my teeth

Matching against training data: How should I take care of my baby's teeth?

TABLE 1

| Ambiguity Resolution Step | Resolution Score |
|---|---|
| Intent Analyzer | 0.88 |
| Keywords Matching | 0.75 |
| Question Category Identification | 0 |
| Vector Matching | 0.936 |
| Final confidence score formula | 0.768 |

Matching against training data: What steps should I follow at home to care for my restored teeth?

TABLE 2

| Ambiguity Resolution Step | Resolution Score |
|---|---|
| Intent Analyzer | 0.66 |
| Keywords Matching | 0.5 |
| Question Category Identification | 0 |
| Vector Matching | 0.766 |
| Final confidence score formula | 0.7266 |

Matching against training data: Where do I get the forms to fill out?

TABLE 3

| Ambiguity Resolution Step | Resolution Score |
|---|---|
| Intent Analyzer | 0.33 |
| Keywords Matching | 0.33 |
| Question Category Identification | 0.5 |
| Vector Matching | 0.61 |
| Final confidence score formula | 0.561 |

User input: how should I fill the application form
Matching against training data: How should I take care of my baby's teeth?

TABLE 4

| Ambiguity Resolution Step | Resolution Score |
|---|---|
| Intent Analyzer | 0.16 |
| Keywords Matching | 0.5 |
| Question Category Identification | 1 |
| Vector Matching | 0.54 |
| Final confidence score formula | 0.452 |

Matching against training data: What steps should I follow at home to care for my restored teeth?

TABLE 5

| Ambiguity Resolution Step | Resolution Score |
|---|---|
| Intent Analyzer | 0.12 |
| Keywords Matching | 0.33 |
| Question Category Identification | 1 |
| Vector Matching | 0.6 |
| Final confidence score formula | 0.526 |

Matching against training data: Where do I get the forms to fill out?

TABLE 6

| Ambiguity Resolution Step | Resolution Score |
|---|---|
| Intent Analyzer | 0.5 |
| Keywords Matching | 0.66 |
| Question Category Identification | 0 |
| Vector Matching | 0.658 |
| Final confidence score formula | 0.56 |

As can be seen from tables 1-6, the final confidence score is determined upon a comparison between the user input and training data. The training data is stored in the database 208 of the conversation platform 200.

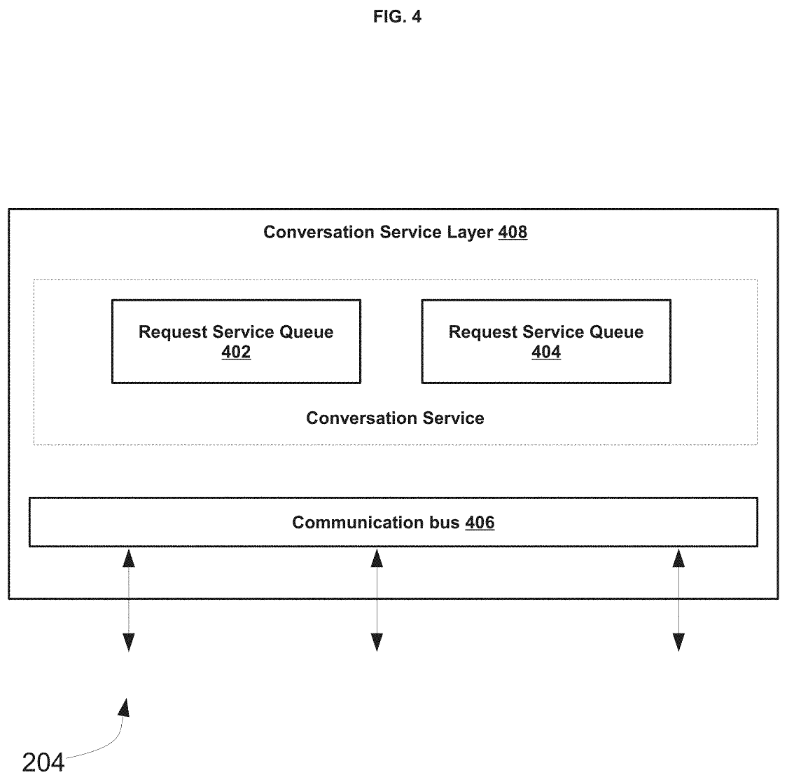

FIG. 4 is a block diagram illustrating the conversation server 204, according to the embodiment as disclosed herein. In an embodiment, the conversation server 204 includes a conversation service layer 408 having a conversation service and a communication bus 406. The conversation service handles all inbound and outbound communication across all users. The conversation service layer 408 includes a request service queue 402 and a response service queue 404 in the conversation service. The request service queue 402 receives all the inbound user messages. The request service queue 402 manages the high availability and load balancing of the inbound requests. The request service queue 402 connects to the orchestration service 206cc to get the user requests processed. The response services queue 404 receives all outbound messages and routes them appropriately to different channels. It is generally called by the response manager which generates the digital agent's responses.

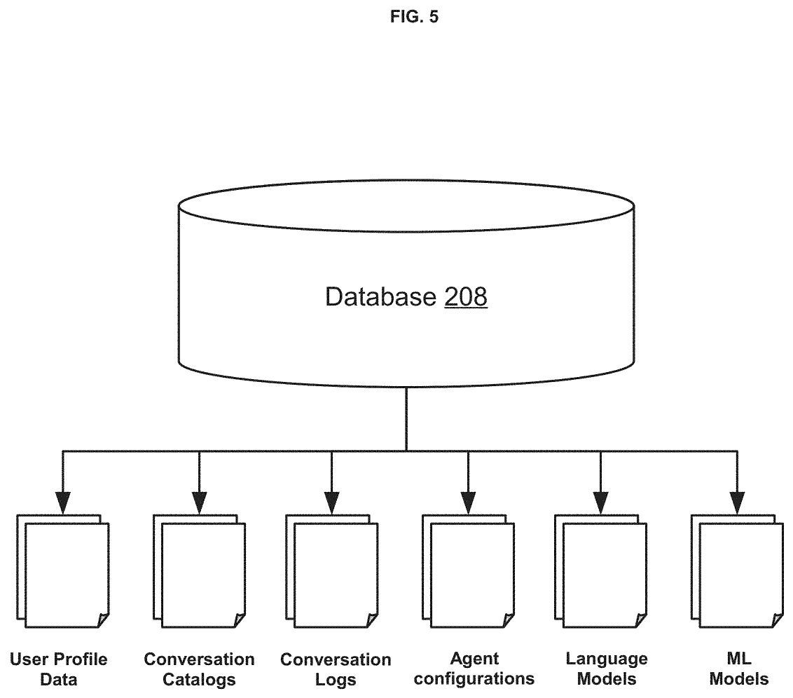

FIG. 5 is an example schematic of the database 208 showing the various kinds of data that can be stored in the database 208, according to the embodiment as disclosed herein. In an embodiment as shown in FIG. 5, the database 208 stores information relating to user profile data including but not limited to history of user interactions and user preferences, conversation catalogs containing domain specific information to train agents on specialized topics (for example, dental practice), conversation logs used to store information about goal progress and any intermediate information for agents to access during a conversation, agent configuration data, language models to be able to convert user input in multiple languages to a common language representation for agents process and to communicate back to users in the language of their preference, and machine learning (ML) models for training agents to gain expertise in one or more domains or specialties.

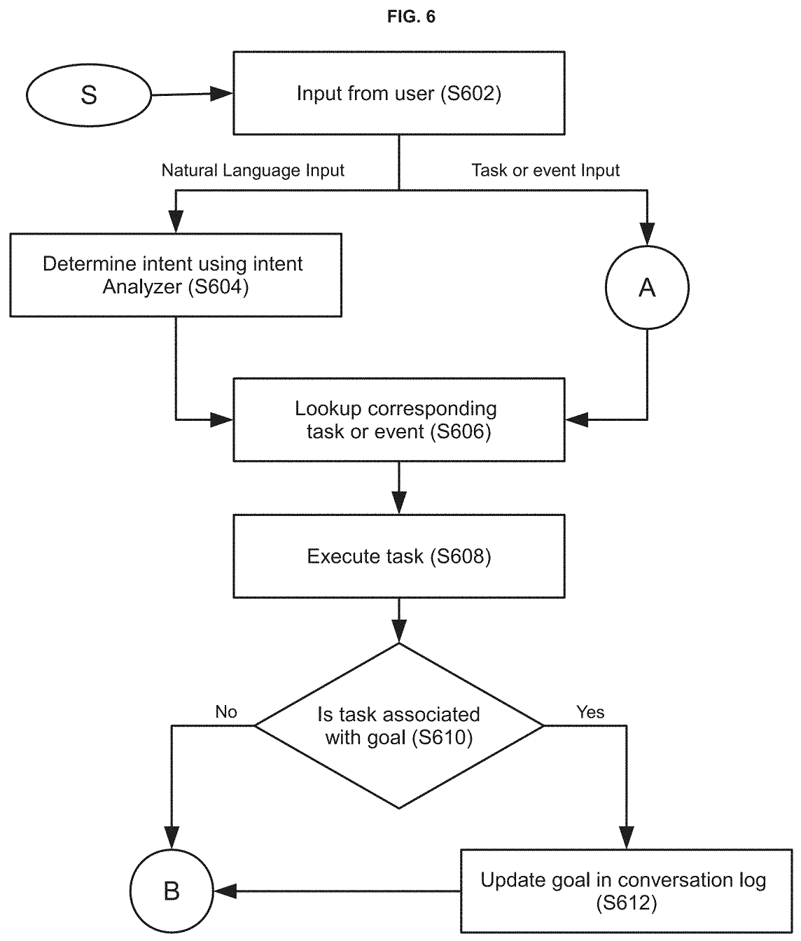

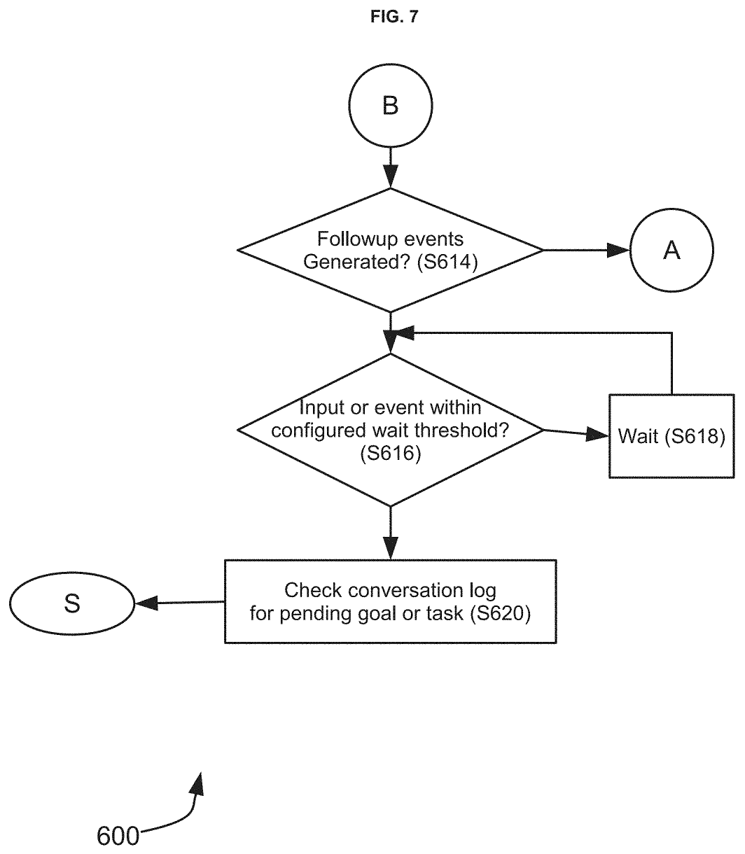

FIGS. 6 and 7 are illustrating flow diagrams 600 of a process of engaging in a conversation with the user by an agent configured on the conversation platform 202, according to the embodiment as disclosed herein. In an embodiment as shown in FIGS. 6 and 7, the process starts (S602) with user interacting with the agent through an interface (for example, chatbot on a website). The user input can be interpreted by the agent either as a natural language input or as a direct instruction to perform a pre-configured task known to the agent. In one example, the input can be a request for information (for example, about services offered by a specific dental practice). Such requests for information may not be directly mapping on to any of the pre-configured tasks and can be interpreted as natural language input. In another example, the input can be a question (for example, about hours of operation about a dental practice) which may map onto a pre-configured task as part of the agent configuration.

When the input is a natural language input, the agent uses (S604) intent analyzer module of the conversation platform 202 to determine intent of the user. The determined intent from user can be a configured event which may associated one or more tasks. Based on the intent of the user, the event analyzer lookup (S606) corresponding task or event. From the natural language input, the intent analyzer may also extract important information which is required for performing the associated task. Based on the important information, the task controller 206ch executes (S608) the task.

When the input is an instruction, the instruction is mapped to a corresponding event. The event can be a configured event with associated one or more tasks.

Consider, when the user sends the natural language input to the agent, that input is first checked against the list of possible instructions. If there is no match, the input is sent to the intent analyzer to perform natural language processing to identify the intent. If the natural language input matches with a known instruction or an intent, it is considered as the event.

The identified event is to trigger one or more associated tasks. Subsequently, the task is executed. Further, the goal analyzer 206cf determines (S610) that task is associated with a goal. If the task is associated with the goal, the conversation log relating to the goal is updated (S612) with the status of the task. Depending on the nature of task, log may be updated one or more times during task execution.

In an embodiment, if the input is not identified, the conversation platform 200 implements an ambiguity resolution (S624) by comparing the input with trained intents stored in the database 608.

Steps involved in ambiguity resolution are as follows. Each step produces a confidence score which is applied to a final formula to predict the final resolution score.
1. Intent analyzer
2. Keywords matching (synonyms and lemmatization matching)
3. Question category identification
4. Vector matching
5. Final confidence score formula

The objective analyzer 206cd classifies the user query into one or multiple intents. The two components are the baseline of the analyzer, namely Pretrained Embeddings (Intent_classifier_sklearn) and Supervised Embeddings (Intent_classifier_tensorflow_embedding). Keywords are the words extracted from the user query after removing stopwords (is, but, and, what, why etc). These keywords are supposed to be the topic of the user message (the topic of interest which the user is talking about). The list of these keywords is extended by adding synonyms of each keyword along with any custom synonyms which may have been configured.

This list is further enhanced by applying lemmatization for each keyword and all other lemmatization forms of it added to the list. The same procedure is applied to each statement in the training data as well. These keywords lists of user input and each of the training statements is compared to look for similar keywords. The scale of equivalence between the two lists gives a confidence score for this step.

The user input is passed through a question category prediction algorithm which classifies its top level intent category. Each statement in a conversation will fall under at least one of the categories. Some of the intent category examples are describe_person_intent, ask_datetime_intent, ask_help, describe_place_intent etc.

The same procedure is applied on each statement of the training data as well and their intent categories are found. The scale of equivalence between these intent categories gives a confidence score for this step.

Au query is converted into the string vector using the Spacy library along with glove model and compared with the trained intents in the vector format. The comparison score is calculated based on the Euclidean distance.

The final score will be calculated based on the following formula:—

Final equivalence score: intent_analyzer_score*0.3+question_category_score*0.1+vector_score*0.1+keywords_synonyms_score*0.5

The various suggestion with regard to the intents are displayed to the user at the client device 214a-214c (S626).

The agent checks (S614) if there are follow-up events configured for the task. In various embodiments, the conversation server 204 may update goals or follow-up events based on the context of the conversation. For example, if a promotion is going on relating to a service, the conversation server 204 may assign (S616) a new goal to direct user to a relevant information portal for user to review new promotions relating to the service that user was already in a conversation.

When there are follow-up events generated based on the completed task, the process continues with look up of relevant tasks. When there are no subsequent events generated, the process waits (S618) for a configured threshold wait time period for any events to act upon and checks for events on a periodic basis. When an event or input is received during the wait period, the whole process repeats from the beginning. If the input or event is executed within the threshold time then the goal analyzer 206cf checks (S620) the conversation log for next pending goal or task to proceed.

As illustrated in the process of FIGS. 6 and 7, goals with associated tasks and dynamic input can make an agent continue to work in pursuit of one or more goals.

The various actions in method 600 may be performed in the order presented, in a different order or simultaneously. Further, in some embodiments, some actions listed in FIGS. 6 and 7 may be omitted.

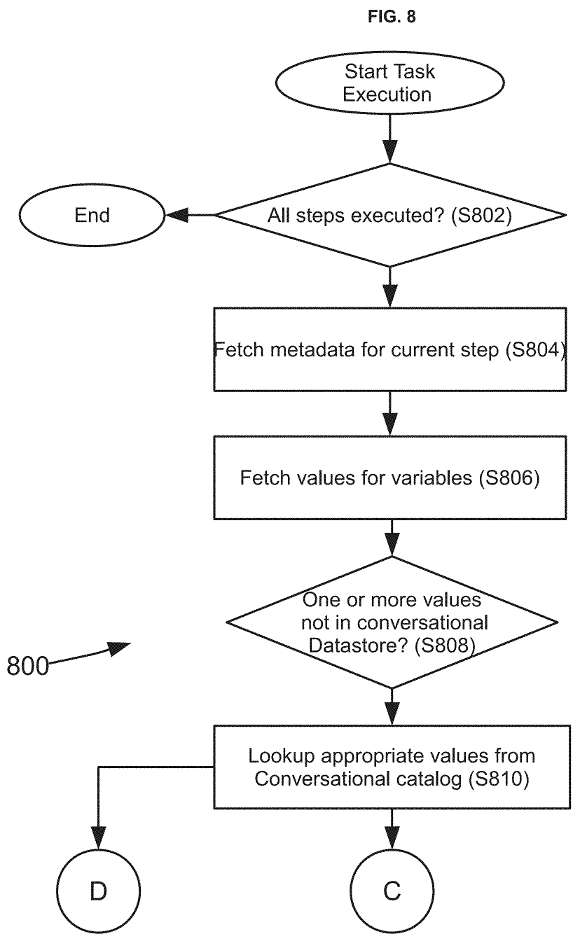

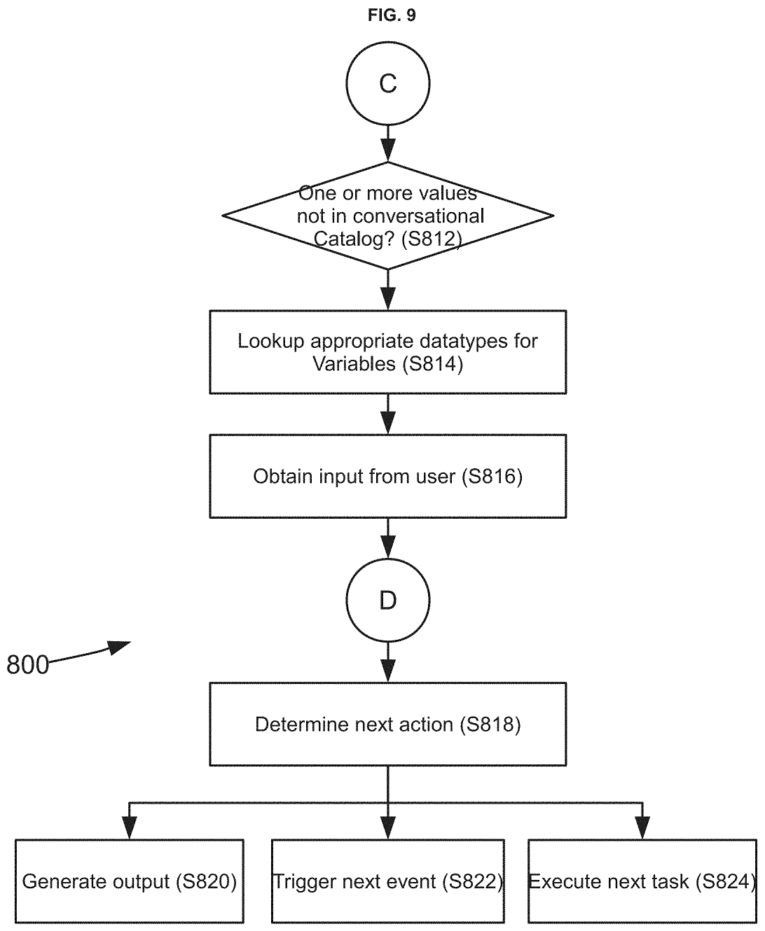

FIGS. 8 and 9 are illustrating flow diagrams 800 the process of executing a task, according to the embodiment as disclosed herein. Executing a task involves executing (S802) one or more steps related to the task. The process is deemed completed when all associated steps are completed. When all steps are completed, the process terminates. Otherwise, the metadata relevant to the current step is fetched (S804). Subsequently, the values for variables are fetched (S806) from the configurations. The task controller 206ch determines (S808) that values for variables are not available in configuration datastore. When values for variables are not available in configuration datastore, the values for the same are looked up (S810) in the conversation catalog. The task controller 206ch determines (S812) that one or more values not in the conversational catalog. Subsequently, for any variables for which values cannot be obtained, the information relating to datatypes is obtained (S814) to be able to take input from user for the variables. The task controller 206ch obtains (S816) the input from the user. Based on the information collected from configurations, conversation catalog and user input, the next action to be performed is determined (S818). In various embodiments, the agent may check with conversation server 204 to provide input on next action to be performed. Accordingly, the agent can perform the next action. The next action can be generating (S820) output, triggering (S822) an event to perform one or more tasks, or executing (S824) another specific task.

The config metadata of each task and its steps will be stored in the conversation log when the conversation starts, so that the agent will fetch the next step's metadata from the conversation log and then execute it. In an example, the metadata of the “Get value from the user” step will have the operation and the list of variables for which values have to be obtained from the user. Book an appointment task will have a get value step for the user name, email and timeslot. The meta-data will look like below:

[

Operation: GetValue,
Parameters: Customer.Name, Customer.Email,
Appointment.DateTime, Prompts: {
Customer.Name: [“Can you please tell me your name?”, “What is
your name?”],
Customer.Email: [“What is your email id?”, “How can I contact
you by email?”],
Appointment.DateTime: [“What is your preferred time slot?”,“When
do you want to come for the appointment?”]
}

]

In this case, when the agent encounters this step, it has to ask the user for their name, email and their preferred appointment time slot. So, it will check the meta data prompts for possible ways it can ask the user for a specific information. If it doesn't find any prompt for a particular variable, it will consult the conversation context catalog by passing the operation and the variable name to get the question it can ask the user to get that information. If it doesn't find a possible question even in the conversation context catalog, it will find the data type of the variable and consult the conversation context catalog of how it can ask the user for information for that particular data type. In this instance, let's say there is no prompt for Appointment.DateTime in the step meta data. The agent will send a request to the conversation context catalog asking for a possible suggestion on how it should ask the user for appointment date by passing [operation:GetValue, context: Appointment.DateTime]. If it doesn't find a match, it will again ask the conversation context catalog for a suggestion by passing [operation:GetValue, context:Date]. This way, the agent can figure out how to ask for different types of information from the user in a context specific way.

After performing the step, the agent may check with the conversation server 204 to determine the next step. Generally, it will be the next step in the task, but sometimes, the conversation server 204 may determine other conditions which may force the agent to take an alternate route in the conversation.

For example: After displaying the services offered by the dentist, the agent asks the user if they want to book an appointment. The user says no. At this point, the general flow mandates that the book an appointment task ends. But the system may check some other conditions which may result in instructing the agent to provide a discount on the consulting fees to persuade the user into booking an appointment. So, in this case, the agent may reply that it can give a 30% discount on the consulting fees if the user books an appointment now which may lead to a successful lead conversion for the business owner.

The various actions in method 800 may be performed in the order presented, in a different order or simultaneously. Further, in some embodiments, some actions listed in FIGS. 8 and 9 may be omitted.

As mentioned earlier, the digital agent works on the principle of “Tasks”. A task is a unit of work which can be performed to accomplish a particular objective. For a dental digital receptionist, “Book appointment, “Show doctor's information”, “Show clinic information”, “Get feedback”, etc will each be a task.

All possible conversation flows, which the customer may have with the agent, have to be thought through and configured as a decision tree. Any deviation may have to be handled properly or the conversation may hit a dead end. Also this type of configurations tend to remain static and don't learn by studying the usage statistics and adjust to customer behavior.

The possible options provided to the customer at each step of the conversation is static and has to be modified whenever there are new tasks added or removed. This leads to constant maintenance overhead.

Agent initiated interactions when the customer goes silent (doesn't continue the conversation) is mostly non-existent. The agent's ability to contextually continue the conversation and lead the user to fulfill the business objectives (business goals) cannot be configured.

In order to overcome the above mentioned shortcomings, a custom algorithm has been developed to let the agent determine the best possible next step at any given juncture of the conversation and lead the customer to a business goal.

The conversation platform 200 predicts the next action based on customer usage data (it continuously learns the best possible conversation paths based on customer interactions). It can also use a default logic to predict the next action when there is no sufficient customer usage data as well.

All tasks are tagged based on their objectives. For example, each task is tagged as one of the following—“information task”, “conversion/goal task”, “Knowledge base QA task” and “Live support task”. This metadata helps the agent to establish a default logic to determine the next action when there is not enough usage data available to predict the best possible action.

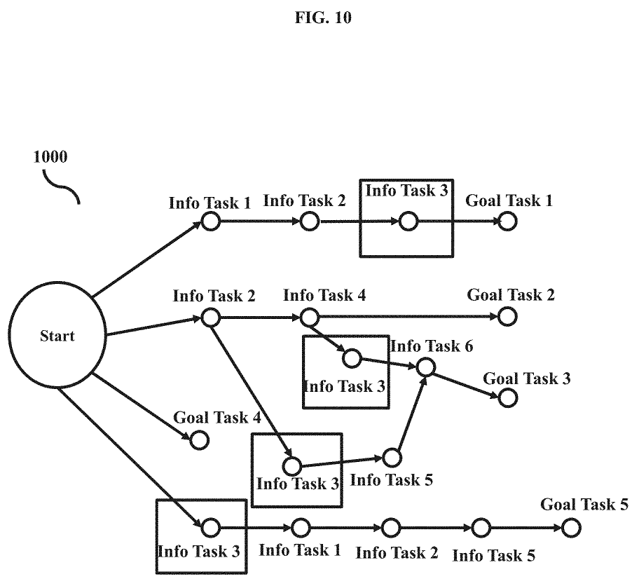

All customer interactions are grouped together into a graph (conversation graph) which behaves as the agents' memory map. FIG. 10 illustrates a sample memory map

Referring to FIG. 10, if the conversation agent is in the middle of a conversation with a customer while a current task (info task 3) is being executed. After executing the task, the agent has to determine the next best goal based action. The first step for the conversation platform 200 is to identify places where info task 3 appears. Once these positions are determined, the algorithm uses the following formula to determine the

best possible path to lead the customer to a business goal.

$${\sum }_{i - 1}^{n} [ ( \frac{No . of steps to Goal ( i )}{Goal weightage ( i )} ) * ( \frac{Goal weightage ( i )}{ \begin{matrix}Total successful goal \\ outcomes in memory\end{matrix}} ) ]$$

Where I=number of paths determined for the same goal and n is the total successful goal outcomes in memory.

Considering the above example, the following will be the calculations.

It is illustrated in FIG. 10 that Info task 3 leads to Goal task 1, Goal task 3 and Goal task 5. Goal task 2 and Goal task 4 will be not be considered for the next action.

Goal task 1 path 1= 1/15 * 15/36=0.0246

Goal task 3 path 1=⅔ * 3/36=0.0528

Goal task 3 path 2=3/3* 3/36=0.083

Goal task 5 path 1= 4/18 * 18/36=0.11

Since goal task 3 has 2 paths, the final score will be the summation of the two individual scores. So the revised scores are as follows.

Goal task 3=0.13

Goal task 5=0.11

Goal task 1=0.02

In this case, the path to goal task 3 will be chosen as the best conversation route to pursue. If the conversation agent initiates a task on its own at this juncture, it will choose to execute Info task 6 as it is the easiest way to get to Goal task 3. If it has to provide a list of suggestions to the user so as to give them possible actions they can take, it will suggest Info task 6 and Info task 5 (both these tasks are on the path to goal task 3) followed by options to directly go to Goal task 3, Goal task 5 and Goal task 1.

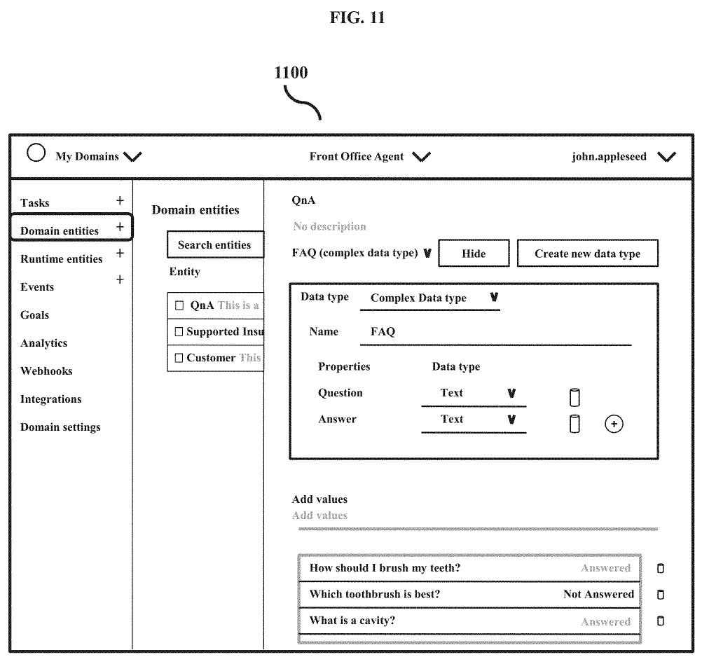

FIG. 11 is an example scenario in which a user interface 1100 is depicted for designing, configuring, customizing and populating custom data-types, according to the embodiment as disclosed herein. Consider, the custom data-types are customized and populated by asking specific information to the user (e.g., How should I brush my teeth?, Which toothbrush is best?, What is a cavity?, etc.

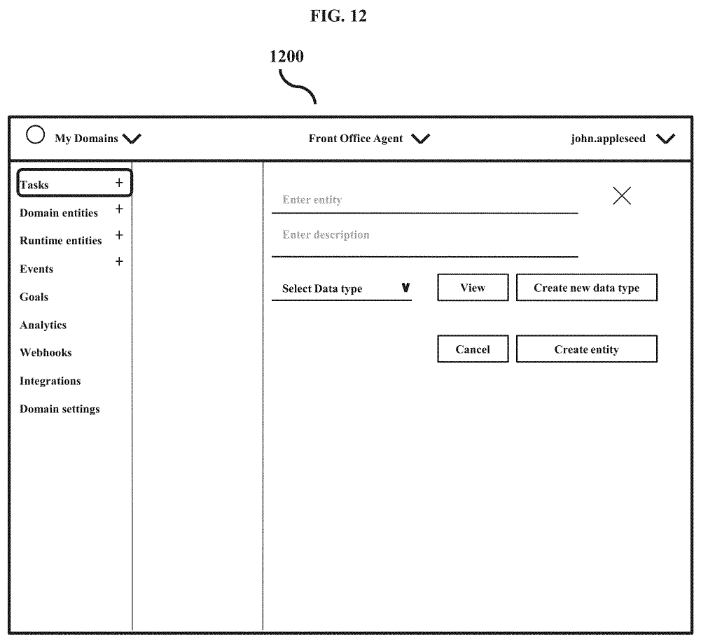

FIG. 12 is an example scenario in which a user interface 1200 is depicted for creating data entities and its related fields, according to the embodiment as disclosed herein. In order to create new data entities, the user interface 1200 allows the user to select various field and create new data entities and its related fields.

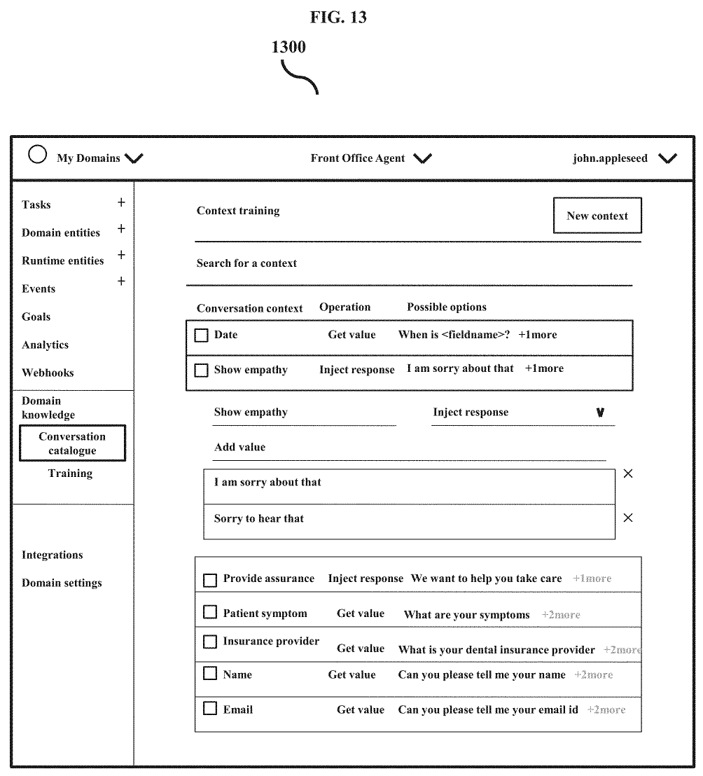

FIG. 13 is an example scenario in which a user interface 1300 is depicted for creating and maintaining context training, according to the embodiment as disclosed herein. In order to provide the context training, the user interface 1300 provides the question and asks the user to get that information related to the question. Based on the context training, the user interface 1300 updates goals or follow-up events based on the context of the conversation.

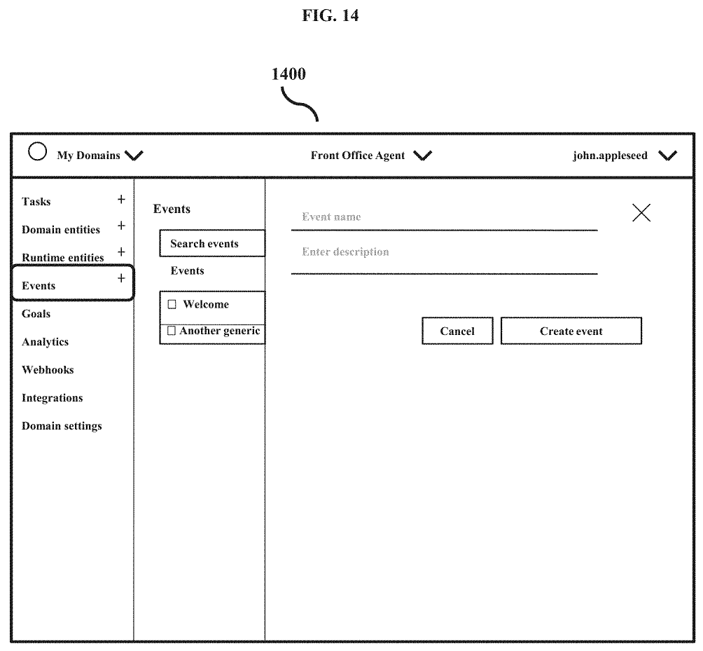

FIG. 14 is an example scenario in which a user interface 1400 is depicted for creating and maintaining events, according to the embodiment as disclosed herein. The user interface 1400 illustrates that various fields (e.g., event name and event description or the like) used for creating the events. After creating the events, the events will be saved by the user.

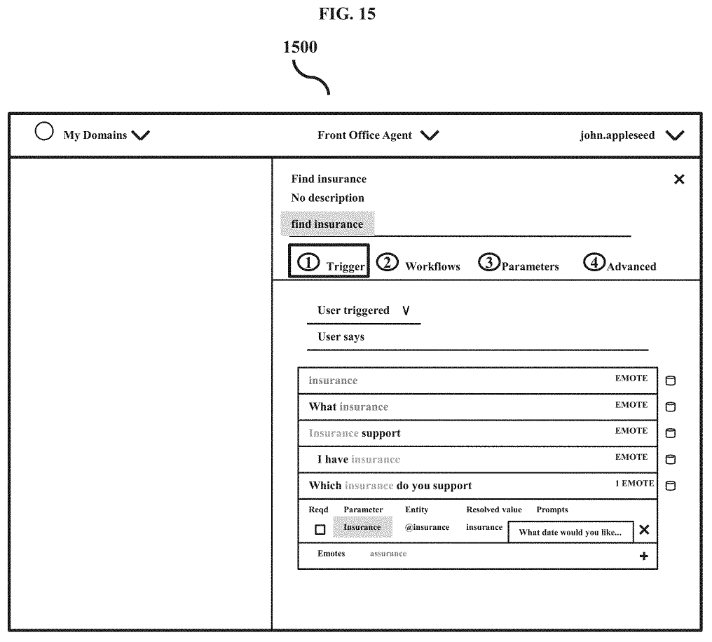

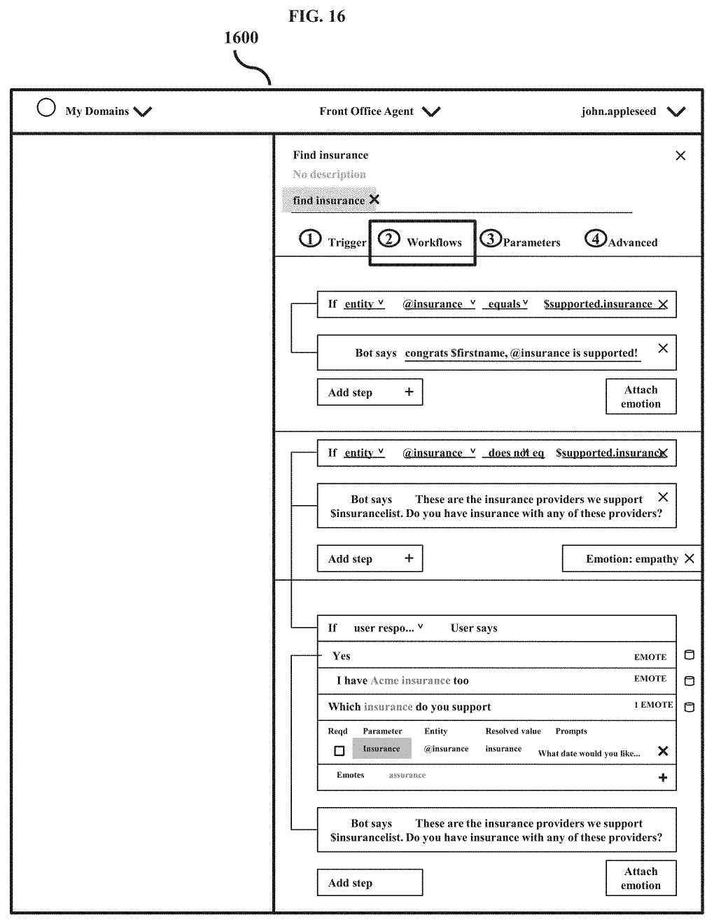

FIG. 15 and FIG. 16 are illustrating example scenarios in which user interfaces 1500 and 1600 are depicted for creating, configuring and customizing tasks, according to the embodiment as disclosed herein. The user interfaces 1500 and 1600 are depicted for creating the tasks by providing task definitions including specific actions. In the FIG. 15 and FIG. 16, the actions can be finding the insurance related information by asking various question related to the insurance. Based on the information, the user interfaces 1400 and 1500 will configure and customize the tasks.

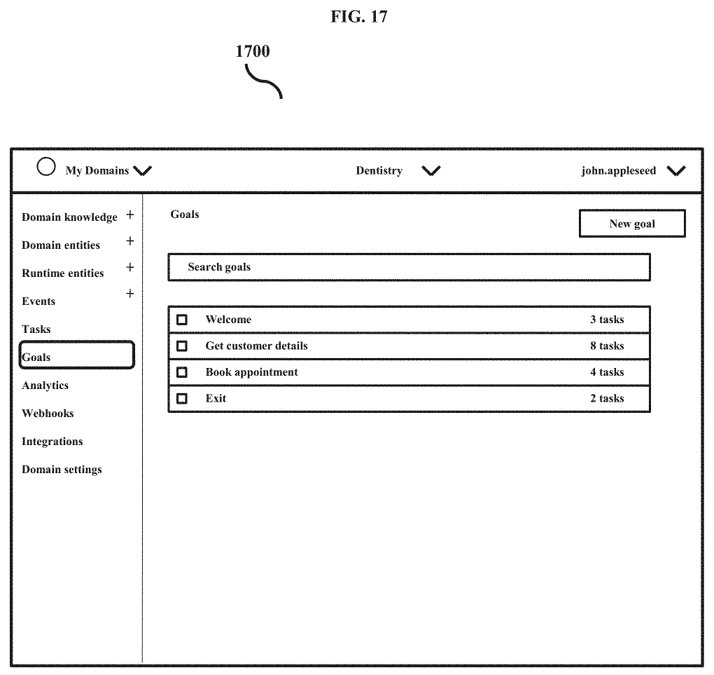

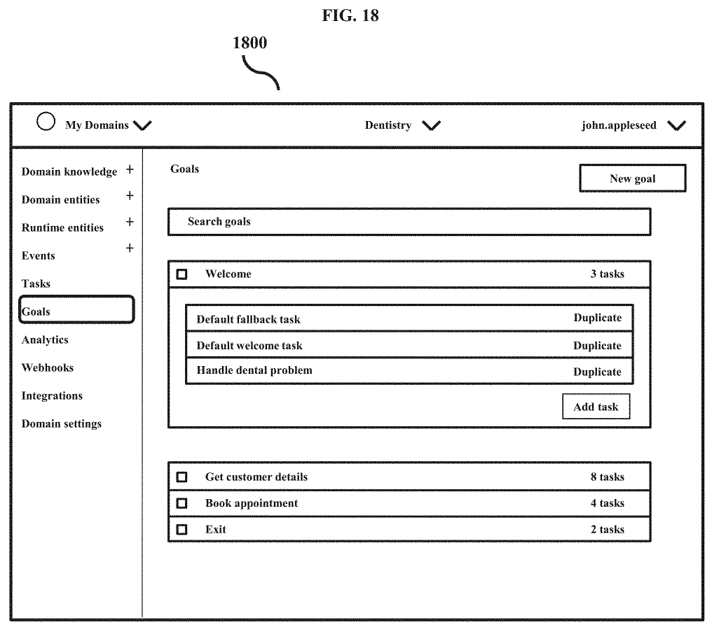

FIG. 17 and FIG. 18 are illustrating example scenarios in which user interfaces 1700 and 1800 are depicted for creating and maintaining goals, according to the embodiment as disclosed herein. Various tasks and dynamic input are provided in the user interfaces 1700 and 1800 for continue to work in pursuit of one or more goals. The goal is obtained by executing the various tasks and dynamic input in the user interfaces 1700 and 1800.

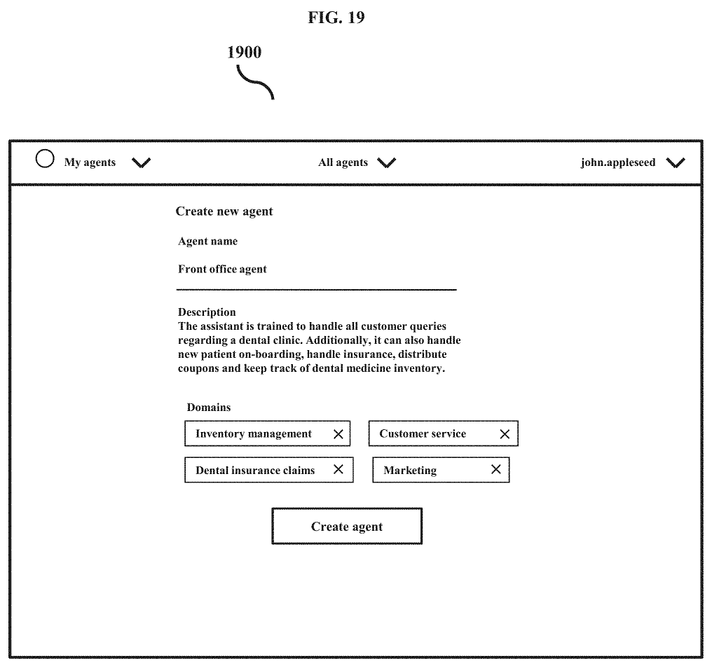

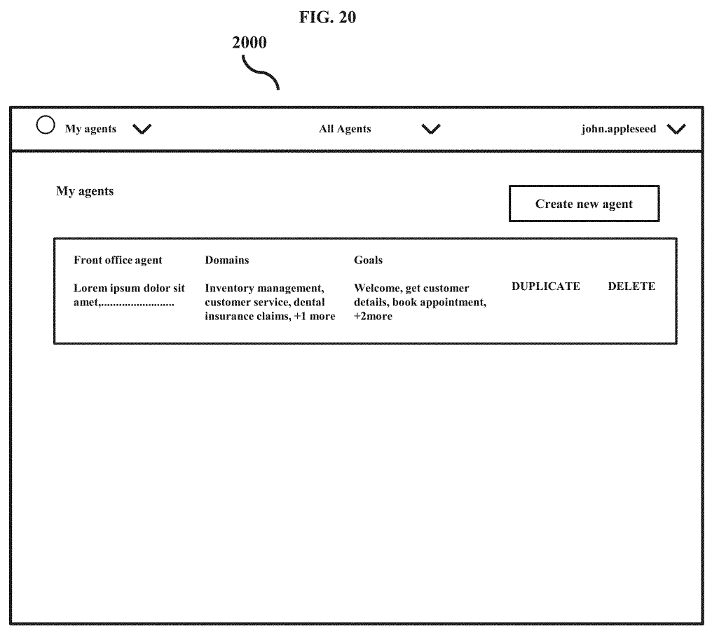

FIG. 19 and FIG. 20 are illustrating example scenarios in which user interfaces 1900 and 2000 are depicted for creating and maintaining agents, according to the embodiment as disclosed herein. As shown in the FIG. 19, various fields (e.g., agent name, description, and domain) are inputted in the user interfaces 1900 to create the agents. After creating the agents, the user can save the agents. Various roles of the agents are checked in the user interface 1900 as shown in the FIG. 19.

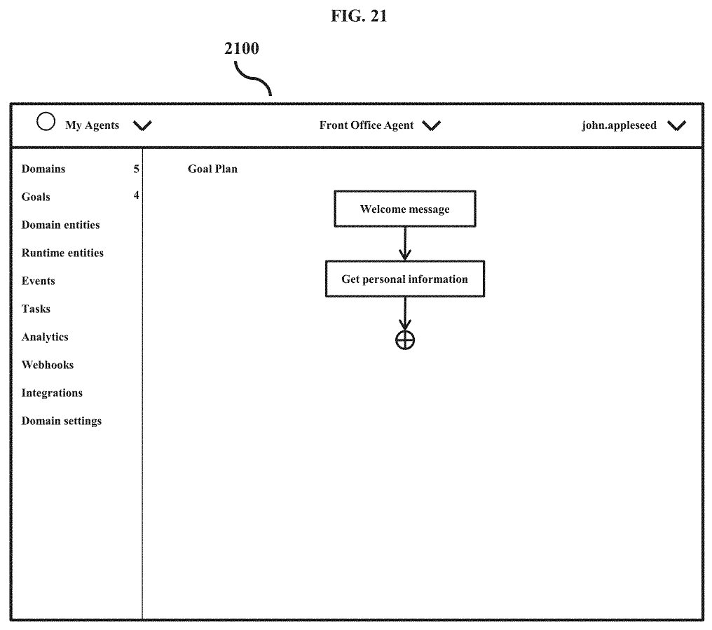

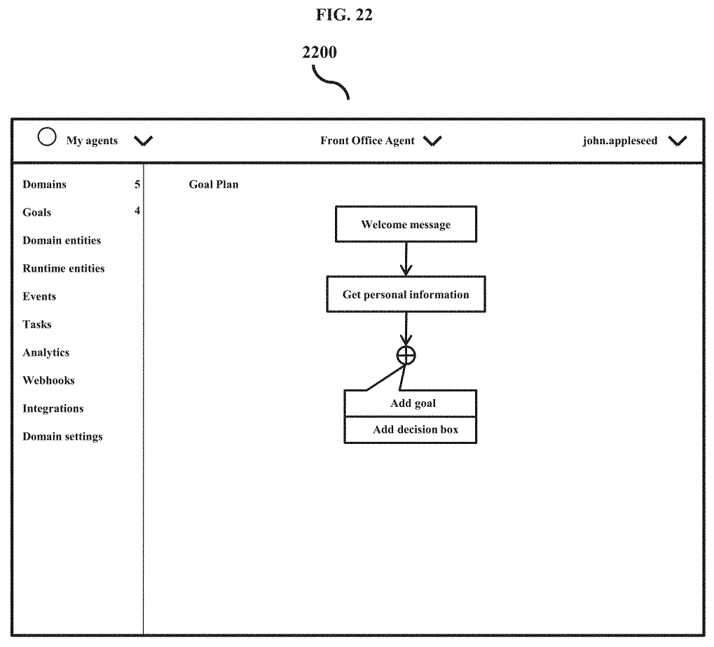

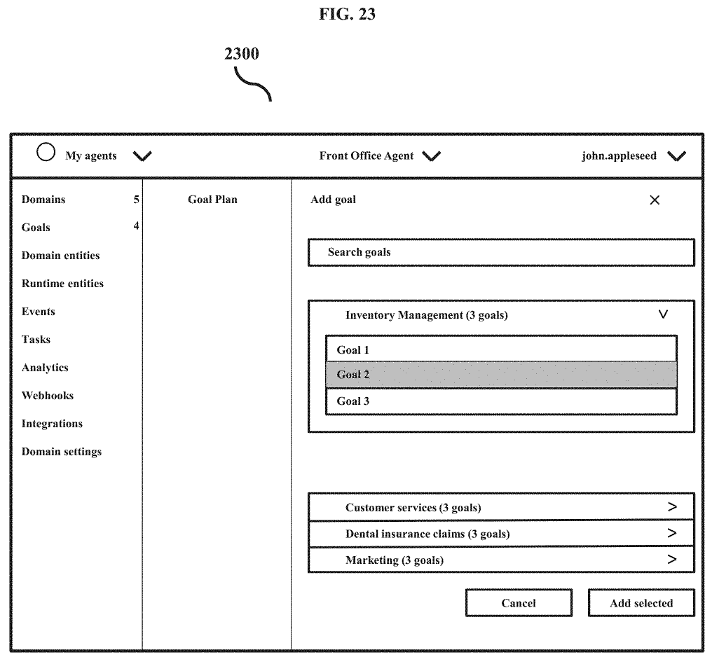

FIGS. 21-23 are illustrating example scenarios in which user interfaces 2100, 2200, and 2300 are depicted for designing, configuring and customizing goal plans, according to the embodiment as disclosed herein. The user interface 2100 is depicted for designing the goal plans by obtaining the personal information as shown in the FIG. 21. The user interface 2200 is depicted for configuring the goal plans by checking decision box corresponding to the goal. Further, the goal plan provides information on the order in which the goals should be executed as shown in the FIG. 22. The user interface 2300 is depicted for customizing the goal plans based on the tasks as shown in the FIG. 23.

The embodiments disclosed herein can be implemented through at least one software program running on at least one hardware device and performing network management functions to control the network elements. The network elements shown in FIG. 2 include blocks which can be at least one of a hardware device, or a combination of hardware device and software module.

It is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for goal-driven conversation on a conversation platform, the method comprising:
receiving, by an application server, configurations for a conversation agent, wherein the configurations comprise:
task configurations,
a goal plan, and
event conditions;
receiving, by the application server, at least one conversational input from a user through the conversation agent;
mapping, by the application server, the input to one of a task and an event;
performing, by the application server, one of:
objective analysis to analyze and identify objective of the input,
event analysis to evaluate event conditions and check for goal triggers for matching event conditions, and
goal analysis to determine a next conversation based on the goal plan; and
initiating conversational interaction with the user based on the analysis.

2. The method of claim 1, wherein objective analysis to analyze and identify objective of the conversational input comprises:
classifying the conversational input into at least one intent;
extracting keywords from the at least one conversational input upon removing stopwords;
converting the intent into a string vector that is compared with trained intents;
generating a confidence score for the at least one intent based on the classified input, comparison with trained intents and extracted keywords; and
displaying the at least one intent based on the confidence score.

3. The method of claim 1, wherein the conversation catalog comprises:
one or more subject definitions;
relationships between subjects, where there are more than one subject definitions;
operations that can be performed; and
conditions and filters that are applied in retrieving information.

4. The method of claim 1, wherein the task configuration comprises:
task definitions including specific actions;
one or more instructional triggers for branching a conversation; and
one or more functional triggers for branching a conversation.

5. The method of claim 1, wherein the goal plan comprises:
a set of one or more tasks;
priority associated with each of the one or more tasks indicating order of execution of tasks; and
one or more conditional triggers for branching out of goal plan.

6. The method of claim 1, further comprising:
triggering one or more associated goal events when an event condition is satisfied.

7. The method of claim 1, further comprising:
executing a chain of associated goal tasks with at least one task when a goal event is triggered, where executing a goal task comprises of:
invoking a pre-configured instruction; and
invoking a pre-configured function,
where executing the first task in the chain of associated goal tasks results in executing further tasks in the chain when there is more than one task in the chain.

8. The method of claim 1, wherein the input is one of a natural language input and an instruction.

9. A system for goal-driven conversation, the system comprising:
a conversation server configured to receive and transmit inbound and outbound communication from at least one user;
an application server configured for:
receiving configurations for a conversation agent, wherein the configurations comprise:
task configurations,
a goal plan, and
event conditions;
receiving at least one conversational input from a user through the conversation agent;
mapping the input to one of a task and an event;
performing, by the application server, one of:
objective analysis to analyze and identify objective of the input,
event analysis to evaluate event conditions and check for goal triggers for matching event conditions, and
goal analysis to determine a next conversation based on the goal plan; and
initiating conversational interaction with the user through the conversation server based on the analysis.

10. The system of claim 9, wherein objective analysis to analyze and identify objective of the conversational input comprises:
classifying the conversational input into at least one intent;
extracting keywords from the at least one conversational input upon removing stopwords;
converting the intent into a string vector that is compared with trained intents;
generating a confidence score for the at least one intent based on the classified input, comparison with trained intents and extracted keywords; and
displaying the at least one intent based on the confidence score.

11. The system of claim 9, wherein the conversation catalog comprises:
one or more subject definitions;
relationships between subjects, where there are more than one subject definitions;
operations that can be performed; and
conditions and filters that are applied in retrieving information.

12. The system of claim 9, wherein the task configuration comprises:
task definitions including specific actions;
one or more instructional triggers for branching a conversation; and
one or more functional triggers for branching a conversation.

13. The system of claim 9, wherein the goal plan comprises:
a set of one or more tasks;
priority associated with each of the one or more tasks indicating order of execution of tasks; and
one or more conditional triggers for branching out of goal plan.

14. The system of claim 9, wherein the system is configured to trigger one or more associated goal events when an event condition is satisfied.

15. The system of claim 9, wherein the system is configured to execute a chain of associated goal tasks with at least one task when a goal event is triggered, where executing a goal task comprises of:
invoking a pre-configured instruction; and
invoking a pre-configured function,
where executing the first task in the chain of associated goal tasks results in executing further tasks in the chain when there is more than one task in the chain.
